(19) United States
(12) Patent Application Publication
(10) Pub. No.: US 2009/0140936 A1
(43) Pub. Date: Jun. 4, 2009

(54) ANTENNA DEVICE OF PORTABLE WIRELESS TERMINAL

(75) Inventors: Young-Jun CHO, Anyang-si (KR); Byung-Man LIM, Seoul (KR); Yong-Jin KIM, Seoul (KR); Jae-Ho LEE, Yongin-si (KR); Yong-Joo SHIN, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/275,984

(22) Filed: Nov. 21, 2008

(30) Foreign Application Priority Data
Nov. 29, 2007 (KR) 10-2007-0122600

(51) Int. Cl. H01Q 1/24

(52) U.S. Cl. 343/702

(57) ABSTRACT

An antenna device for a portable wireless terminal including a main built-in antenna for transmitting and receiving signals of one and more frequency bands is provided. The antenna device includes an external case on which a wireless terminal is disposed. The external case comprises an antenna radiator of at least one. In addition, the antenna device includes a control part for selectively controlling use of at least one of the at least one antenna radiator and a main built-in antenna of the wireless terminal.

### PRIORITY

This application claims the benefit under 35 U.S.C. §119(a) of a Korean patent application filed in the Korean Intellectual Property Office on Nov. 29, 2007 and assigned Serial No. 10-2007-0122600, the entire disclosure of which is hereby incorporated by reference.

### BACKGROUND OF THE INVENTION

1. Field of the Invention

The present invention relates to an antenna device for a portable wireless terminal. More particularly, the present invention relates to an antenna device for improving radiation performance for a portable wireless terminal without increasing its size.

2. Description of the Related Art

Portable wireless terminals such as a Personal Communication Systems (PCS), a Global Positioning Systems (GPS), a Personal Digital Assistant (PDA), cellular phones and wireless notebook computers, are widely being used. Since their introduction, these terminals have evolved into smaller and slimmer devices based on user demand. In addition, these terminals are being provided with various functions in addition to the voice communication function. Therefore, in order to continue satisfying user desires and demands, the design of the terminal is being focused on a size reduction while maintaining or improving the functions, as well as providing new ones.

The portable wireless terminals include an antenna for radio communication. The antenna can be classified into an external type and a built-in type. An external type antenna is installed in a portable wireless terminal in such a manner that it protrudes from the terminal body. In contrast, a built-in antenna is installed on a Printed Circuit Board (PCB, hereinafter also referred to as a mother board) located inside a portable wireless terminal without any external protrusion. Further, an external antenna can be classified into a dipole antenna having a feed part and a ground part or a monopole antenna having only a feed part. The monopole antenna has a feed part electrically connected to a feed pad of a PCB. A built-in antenna can be classified in the same way. The built-in antenna is more widely used than the external antenna because of its portability and the improvements it affords to the portable terminal's external appearance.

Though the performance of the antenna is proportional to the size of the antenna, a large antenna makes the terminal bigger. Therefore, there is a need for an antenna that can improve radiation performance without increasing its size.

FIG. 1 is a perspective view of a conventional bar type portable wireless terminal.

Referring to FIG. 1, the terminal 10 includes a built-in antenna (not shown) for transmitting and receiving signals of a frequency band. Also, the terminal 10 includes an external case 20 on which it is affixed for satisfying desires of user design. Further, the terminal 10 includes an ornamental metal frame 11 and a metal badge 21. The built-in antenna is surrounded by the ornamental metal frame 11 and a metal badge 21. However, the ornamental metal frame 11 and the metal badge 21 may deteriorate a radiation performance of the built-in antenna.

In addition, the portable wireless terminal includes a display, such as a Liquid Crystal Display (LCD) and a touch screen, as a data output/input device. The display of the terminal 10 may reduce a radiation performance of the built-in antenna.

FIG. 2 is a perspective view of a mother board (i.e. PCB) of a conventional portable wireless terminal.

Referring to FIG. 2, the mother board 30 includes built-in antennas 31 and 32 having a pattern for transmitting and receiving signals of a frequency band. As the terminal has evolved into smaller and slimmer devices based on user demand, space to install the built-in antennas 31 and 32 may decrease. In addition, the antenna and other parts, such as various circuit modules, a speaker, a microphone, an oscillator, a battery, etc., are closely located to each other. Consequently, a radiation performance of the antenna is further deteriorated.

Therefore, there is a need to provide an antenna having improved performance.

### SUMMARY OF THE INVENTION

An aspect of the present invention is to address at least the above-mentioned problems and/or disadvantages and to provide at least the advantages described below. Accordingly, an aspect of the present invention is to provide an antenna device for a portable wireless terminal that can improve a radiation performance of a built-in antenna, using an external case with other antennas.

Another aspect of the present invention is to provide an antenna device for a portable wireless terminal that can improve a radiation performance without increasing its size and reduces a Specific Absorption Rate (SAR).

A further aspect of the present invention is to provide an antenna device for a portable wireless terminal that can improve a radiation performance of a conventional built-in antenna or process signals of other frequency bands, that the conventional built-in antenna is not able to process.

A still further aspect of the present invention is to provide an antenna device for a portable wireless terminal that can process signals of frequency bands for Terrestrial Digital Multimedia Broadcasting (T-DMB), Satellite Digital Multimedia Broadcasting (S-DMB) and a wireless local area network, such as a Radio Frequency Identification (RFID), a Bluetooth, etc., using an external case with other antennas.

In accordance with an aspect of the present invention, an antenna device for a portable wireless terminal is provided. The antenna device includes an external case on which a wireless terminal is disposed. The external case comprises at least one antenna radiator. In addition, the antenna device includes a control part for selectively controlling use of at least one of the at least one antenna radiator and a main built-in antenna of the wireless terminal.

In accordance with another aspect of the present invention, a portable wireless terminal including a main built-in antenna for transmitting and receiving signals of one or more frequency bands is provided. The terminal includes an external case on which a wireless terminal is disposed. The external case comprises at least one antenna radiator. In addition, the antenna device includes a control part for selectively controlling use of at least one of the at least one antenna radiator and a main built-in antenna of the wireless terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a perspective view of a conventional portable wireless terminal of a bar type;

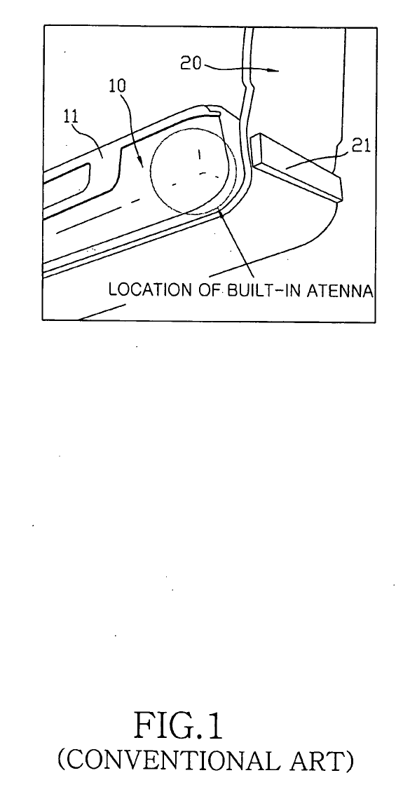

FIG. 2 is a perspective view of mother board (i.e. PCB) of a conventional portable wireless terminal.

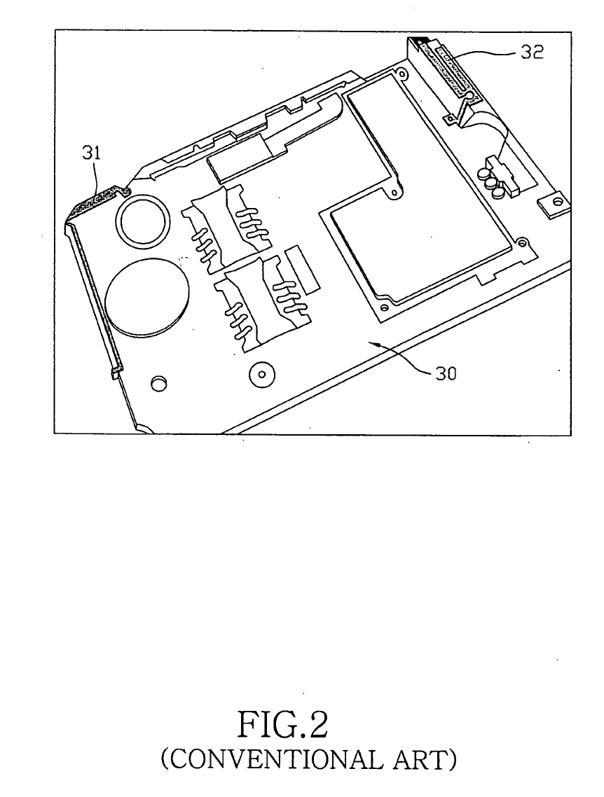

FIG. 3 is a perspective view of an antenna device for a portable wireless terminal according to an exemplary embodiment of the present invention;

FIG. 4 is an exploded perspective view of an antenna device according to an exemplary embodiment of the present invention.

FIG. 5 is a perspective view of a terminal corresponding to direction A of FIG. 4 according to an exemplary embodiment of the present invention.

FIG. 6 is a partial sectional view of an external case including an antenna radiator of a monopole type according to an exemplary embodiment of the present invention.

FIG. 7 is a partial sectional view of an external case including an antenna radiator of a dipole type according to an exemplary embodiment of the present invention.

FIG. 8 is a partial cross-sectional view illustrating separate antenna radiators in an external case according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Though a bar type terminal is described and illustrated, this is merely an example and should not be considered as limiting. That is, the present invention can also be applied to other and various types of terminals, such as a flip type terminal, a folder type terminal and the like.

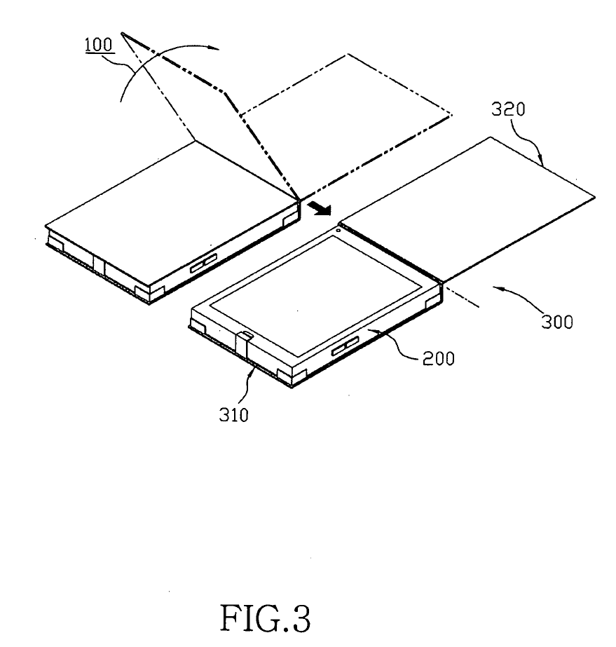

FIG. 3 is a perspective view of an antenna device for a portable wireless terminal according to an exemplary embodiment of the present invention.

Referring to FIG. 3, a portable wireless terminal 200 is affixed on an external case 300 such as a leather case.

The portable wireless terminal 200 includes a main built-in antenna (not shown) for transmitting and receiving Radio Frequency (RF) signals that may be electrically connected to a circuit board (e.g. a motherboard or a Printed Circuit Board (PCB)).

The external case 300 also includes an antenna radiator (hereinafter also referred to as a radiator) to improve a radiation performance of an antenna. The external case 300 includes an attachment part 310 on which the terminal 200 is affixed and a folder part 320 to rotate at an angle 100 with respect to the attachment part 310. In this manner, the terminal 200 is able to be opened and closed. The external case 300 will be explained in more detail below.

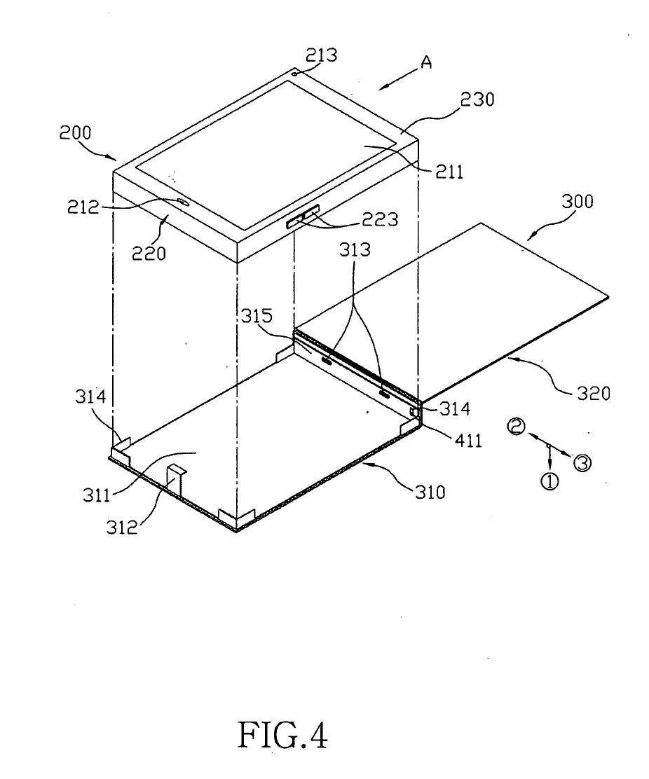

FIG. 4 is an exploded perspective view of an antenna device according to an exemplary embodiment of the present invention.

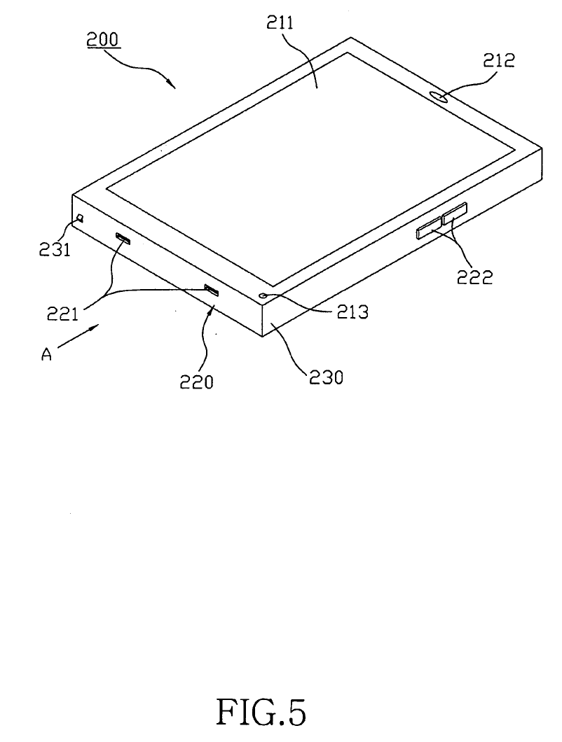

Referring to FIG. 4, the terminal 200 may include a body 220. The body 220 may include a display 211 as a data output device and an earpiece 212 above the display 211 to output voice or other audible signals. In addition, the body 220 may include a microphone 213 under the display 211 for the input of voice and other audio signals. In an exemplary implementation, if the display 211 is provided as a touch screen, the display 211 may perform a part or all of the functions of an input unit. In addition, the body 220 may include key buttons 222 (illustrated in FIG. 5) and 223 as a data input device. In addition, the body 220 may include a case frame 230 to fix the display 211, the earpiece 212, the microphone 213 and the circuit board. In an exemplary implementation, the case 230 may be constructed by injection molding.

Moreover, the terminal 200 may include a control part (not shown) to control the main built-in antenna and the radiator of the external case 300. The main built-in antenna and the control part may be installed on a PCB located inside the terminal 200.

Furthermore, as described above, the external case 300 may include an attachment part 310 on which the terminal 200 is affixed and a folder part 320 to rotate at an angle 100 (illustrated in FIG. 3) with respect to the attachment part 310. In addition, the attachment part 310 and the folder part 320 may be implemented as one body.

The attachment part 310 may include an attachment plate 311 to hold the terminal 200 by an attachment means, such as one or more of a cantilever snap-fit 312 or a fixing protrusion 313. In an exemplary implementation, the attachment plate 311 is made by injection molding. The terminal 200 may be affixed onto the attachment plate 311. Therefore, a side surface 315 of the attachment plate 311 may cover or surround the terminal 200 near the folder part 320. That is, the attachment plate 311 may have a right angle pattern, ‘┘’ for substantially following the contour of the terminal 200.

In an exemplary implementation, the attachment means may use a joining of at least one snap-fit. The joining of the at least one snap-fit may include one or more fixing protrusion 313 projecting perpendicularly from the side surface 315 of the attachment plate 311. In addition, the joining of the at least one snap-fit may include at least one cantilever snap-fit 312 projected upwardly from the attachment plate 311 on the opposite side of the protrusion 313. The at least one snap-fit 312 may include a hook being flexural and recoverable for holding the terminal 200. Further, the case frame 230 of the terminal 200 may include one or more fixing groove 221 (illustrated in FIG. 5) corresponding to the one or more fixing protrusion 313. In addition, the case frame 230 of the terminal 200 may include another groove corresponding to the hook of the at last one snap-fit 312.

If a cross-sectional profile of the side surface of the terminal 200 has a round shape, the side surface 315 of the attachment plate 311 may also have a round shape for substantially following the contour of the side surface of the terminal 200. Herein, the one or more fixing protrusion 313 and the one or more fixing groove 221 may not be necessary. In addition, the attachment means may include at least one wall 314 projecting upwardly from a corner or edge of the attachment 311 for preventing the terminal 200 separating from the attachment plate 311 horizontally.

In another exemplary implementation, if the attachment plate is flexural and recoverable, the attachment means may include a wall including another fixing protrusion opposite the fixing protrusion 313 on attachment plate 311. Herein, the terminal 200 may include fixing grooves corresponding to a pair of fixing protrusion.

In a further exemplary implementation, the terminal can be affixed on the attachment plate 311 by using a magnet or an adhesive.

Moreover, as described above, the folder part 320 may include a radiator (not shown), that has a radiation pattern, to improve a radiation performance of an antenna. In an exemplary implementation, the radiator may be one of a conductive plate, a Flexible Printed Circuit Board (FPCB) and a film made by applying a conductive spray.

In addition, the radiator of the folder part 320 may include an external antenna feed part (hereinafter also referred to as a feed part) 411 projected from the side surface of the attachment plate 311. By mounting the terminal 200 on the attachment part 310, the feed part 411 of the radiator is connected to an external antenna feed connector 231 of the terminal 200. Herein, the radiator of the folder part 320 may be flexible to avoid breaking at a part connected to the attachment part 310 and the folder part 320.

Moreover, the external antenna feed connector 231 of the terminal 200 may be connected to a PCB including an RF module (not shown) of the terminal 200. In addition, the RF module may be controlled by a control part (not shown).

FIG. 5 is a perspective view of the terminal corresponding to direction A of FIG. 4 according to an exemplary embodiment of the present invention.

Referring to FIG. 5, the terminal 200 may include an external feed connector (hereinafter also called a feed connector) 231 connecting to the feed part 411 of the external case 300 by mounting the terminal 200 on the external case 300. The feed connector 231 may be electrically connected to the PCB within the terminal 200 and may be exposed to the case frame 230. The feed connector 231 may provide the radiator of folder part 320 with an electrical signal, for example an electrical current. Therefore, the radiator of the folder part 320 radiates a signal. In addition, the feed connector 231 may provide a mechanical pressure against the antenna feed connector 411 for keeping the antenna feed connector 411 and feed connector 231 in electrical contact.

As described above, the terminal 200 may include the one or more fixing groove 221 corresponding to the one or more fixing protrusion 313.

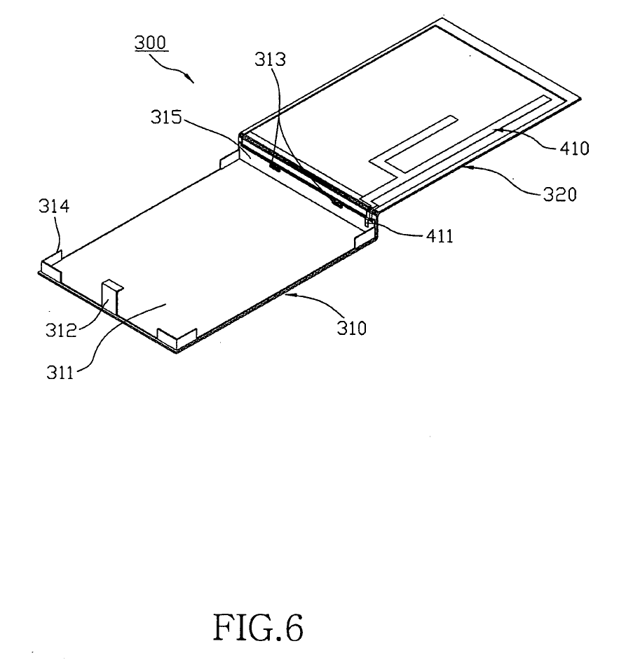

FIG. 6 is a partial cross-sectional view illustrating an antenna radiator of a monopole type in an external case according to an exemplary embodiment of the present invention.

Referring to FIG. 6, the folder part 320 may include a radiator 410 having a radiation pattern for transmitting and receiving signals of a frequency band. In addition, the radiator 410 may include the feed part 411 projected to the side surface of the attachment plate 311 and exposed to the outside. Based on the configuration of the attachment plate 311 onto which the terminal 200 is affixed, the feed part 411 may be electrically connected to the feed connector 231 of the terminal. Herein, the feed connector 231 may be connected to a PCB including an RF module (not shown) of the terminal 200. The feed connector 231 may provide the radiator 410 with an electrical signal, for example an electrical current. Therefore, the radiator 410 may radiate as an antenna of a monopole type.

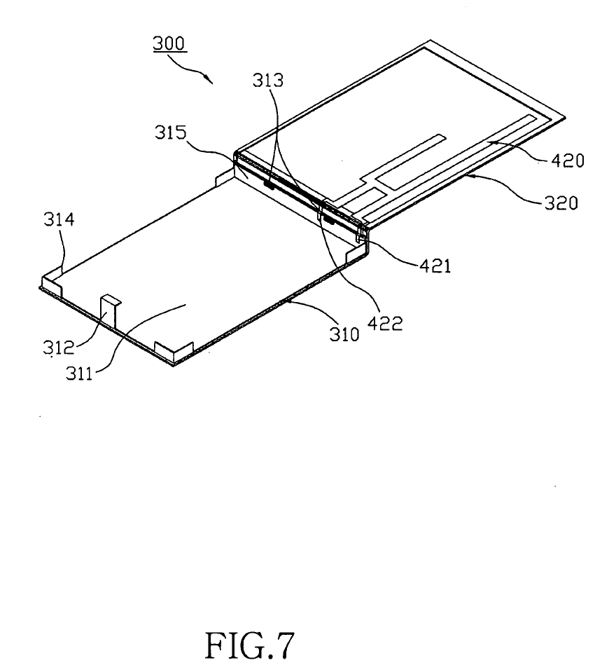

FIG. 7 is a partial cross-sectional view illustrating an antenna radiator of a dipole type in the external case according to an exemplary embodiment of the present invention.

Referring to FIG. 7, an antenna radiator 420 of dipole type may include a feed part 421 and a ground part 422 projected to the side surface of the attachment plate 311 and exposed to the outside. Herein, the terminal affixed onto the external case 300 may include a feed connector and a ground connector corresponding to the feed part 421 and the ground part 422. The feed connector and the ground connector of the terminal may be connected to a PCB including an RF module. Based on the configuration of the attachment plate 311, onto which the terminal is affixed, the feed part 421 may be electrically connected to the feed connector, and the ground part 422 may be electrically connected to the ground connector. The feed connector may provide the radiator with an electrical signal, for example an electrical current. Therefore, the radiator 420 may radiate as a dipole antenna, such as an antenna radiator of a Planar Inverted F Antenna (PIFA).

As described above, the terminal affixed on the external case may include a main built-in antenna transmitting and receiving signals of a frequency band, such as a Digital Cellular System (DCS), a Personal Communication System (PCS), a Global System for Mobile communication (GSM), a Code Division Multiple Access (CDMA) etc.

In addition, the external case may include the antenna radiator 410 or 420 illustrated in FIGS. 6 and 7 according to exemplary embodiments of the present invention. Here, the radiator 410, 420 and the main built-in antenna are able to radiate individually and selectively.

For example, as the radiator 410 or 420 may transmit and receive equivalent signals of frequency bands that the main built-in antenna is able to transmit and receive, the radiator 410 or 420 may improve a radiation performance of the terminal. More particularly, as the folder part 320 opens or shuts with respect to the attachment part 310, a performance of the main built-in antenna and the antenna radiator 410 or 420 may change. Here, as explained in detail below, the control part may compare a signal strength of the main built-in antenna to a signal strength of the radiator 410 or 420 continuously or periodically. Accordingly, the control part may selectively switch which antenna is being used based on the antenna experiencing a higher signal strength. In other words, the control part may selectively switch which antenna is being used on a PCB including an RF module to provide improved signal strength for call and call waiting of the terminal.

For further example, the radiator 410 and 420 may transmit and receive signals of at least one of additional frequency band than that which the main built-in antenna is able to transmit and receive. Here, the control part switches selectively. As explained in greater detail below, the main built-in antenna may process signals of frequency bands, such as PCS, DCS, GSM, etc., for call and call waiting, and the radiator 410 or 420 may process signals of frequency bands, such as a Digital Multimedia Broadcasting (DMB), a Radio Frequency Identification (RFID) etc., that are difficult to embody in the built-in antenna. Herein, the control part is normally connected to the main built-in antenna for call and call waiting, and switches to the radiator 410 or 420 if necessary.

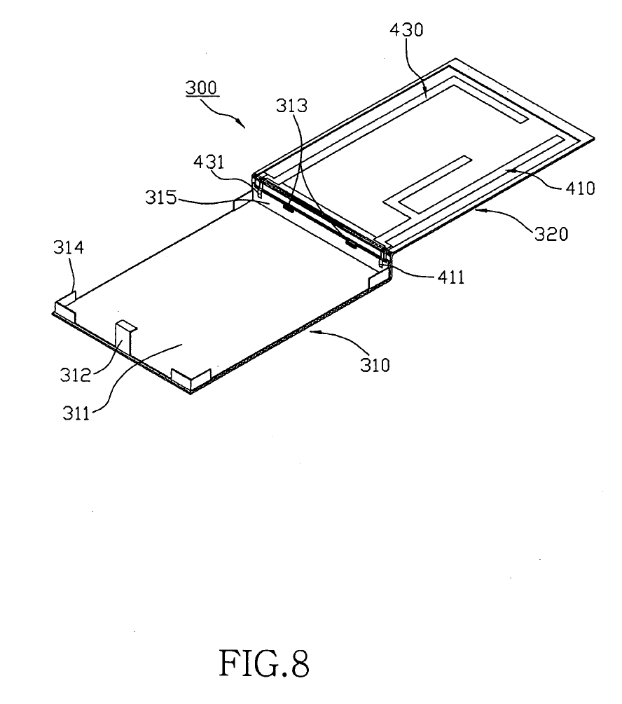

FIG. 8 is a partial cross-sectional view illustrating separate antenna radiators in an external case according to an exemplary embodiment of the present invention.

Referring to FIG. 8, the external case 300 may include a radiator 410 for transmitting and receiving signals of a first frequency band and a radiator 430, spaced apart from the radiator 410, for transmitting and receiving signals of a second frequency band. The radiator 410 and 430 may be substantially in the same plan, and they may separately process signals of multiple frequency bands.

In the illustrated example, the radiator 410 and 430 may include feed parts 411 and 431 that are projected to the side surface of the attachment plate 311 and exposed to the outside for applying an antenna of monopole type. In addition, a terminal affixed on the external case 300 may include separate feed connectors corresponding to the feed parts 411 and 431. By mounting the terminal on the external case 300, the feed parts 411 and 431 are electrically connected the feed connectors of the terminal. The feed connectors may be electrically connected to a PCB including an RF module. Here, the feed connectors may provide the radiator 410 and 430 with an electrical signal, for example an electrical current. Therefore, the radiator 410 and 430 may radiate individually.

Furthermore, the radiator 410 or 430 may further include a ground part, protruding from one end of the radiator 410 or 430 for applying an antenna of a dipole type, such as an antenna of a PIFA type. Here, the terminal affixed onto the external case 300 may further include ground connectors corresponding to ground parts of the radiator 410 and 430.

In the same manner, the radiator 410, 430 of the external case 300 and a main built-in antenna of the terminal may radiate individually and selectively. Descriptions thereof will be omitted.

Table 1 shows a radiation performance corresponding to various antennas.

TABLE 1

| Antenna type | Effect | CDMA | GSM | DCS |
|---|---|---|---|---|
| Conventional | Average Gain[db] | −6.09 | −8.24 | −6.09 |
| built-in antenna | Efficiency[%] | 20 | 15 | 20 |
| Leather cover | Average Gain[db] | −3.01 | −3.47 | −4.20 |
| external antenna | Efficiency[%] | 50 | 45 | 38 |

Referring Table 1, a radiation performance of a terminal using a cover including an external antenna according to an exemplary embodiment of the present invention is better than that of a terminal using only a conventional built-in antenna in the frequency bands used for Code Division Multiple Access (CDMA), a Global System for Mobile communication (GSM) and a Digital Cellular System (DCS).

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An antenna device for a portable wireless terminal including a main built-in antenna, the device comprising:
an external case on which a wireless terminal is disposed;
at least one antenna radiator comprised in the external case; and
a control part for selectively controlling use of at least one of the at least one antenna radiator and a main built-in antenna of the wireless terminal.

2. The device of claim 1, wherein the at least one antenna radiator transmits and receives signals of a same or different frequency bands from frequency bands transmitted and received by the main built-in antenna.

3. The device of claim 1, wherein the external case includes an attachment part for retaining the wireless terminal and a folder part for rotating with respect to the attachment part.

4. The device of claim 3, wherein at least one of the attachment part and the folder part include the antenna radiator.

5. The device of claim 3, wherein the attachment part includes an attachment plate for retaining the wireless terminal, and for one of covering and surrounding the wireless terminal near the folder part.

6. The device of claim 5, wherein the attachment part comprises at least one pair of cantilever snap-fits for retaining the wireless terminal, wherein each cantilever snap-fits engages an opposite portion of the wireless terminal and projects upwardly from an upper part of the attachment plate.

7. The device of claim 5, wherein the attachment part comprises a fixing protrusion and a cantilever snap-fit, facing each other, for retaining the wireless terminal, wherein the fixing protrusion projects perpendicularly from a side surface of the attachment plate, and the cantilever snap-fit projects upwardly from an upper part of the attachment plate, and further wherein the wireless terminal includes a groove corresponding to the fixing protrusion.

8. The device of claim 5, wherein the attachment part comprises at least one pair of fixing protrusion, facing each other, for retaining the wireless terminal, wherein each fixing protrusion projects perpendicularly from a side surface of the attachment plate, and the attachment plate is flexural and recoverable, further wherein the wireless terminal includes grooves corresponding to the fixing protrusions.

9. The device of claim 3, wherein the attachment part comprises a wall projecting upwardly from an upper part of the attachment plate, following the contour of the wireless terminal, for preventing the wireless terminal from separating horizontally from the attachment part.

10. The device of claim 1, wherein the antenna radiator comprises one of a monopole type antenna and a dipole type antenna.

11. The device of claim 1, wherein the antenna radiator comprises at least one of a conductive plate, a Flexible Circuit Board (FPCB) and a sprayed film.

12. The device of claim 1, wherein the antenna radiator transmits and receives signals of at least one of a Digital Multimedia Broadcasting (DMB) and a wireless local area network.

13. The device of claim 2, wherein the control part selectively controls use of the at least one of the at least one antenna radiator and the main built-in antenna by comparing a signal strength of the at least one radiator with a signal strength of the main built-in antenna.

14. A terminal including a main antenna for transmitting and receiving signals of one or more frequency bands, the terminal comprising:
an external case on which a wireless terminal is disposed;
at least one antenna radiator comprised in the external case; and
a control part for selectively controlling use of at least one of the at least one antenna radiator and a main built-in antenna of the wireless terminal.

15. The terminal of claim 14, wherein the at least one antenna radiator transmits and receives signals of a same or different frequency bands from frequency bands transmitted and received by the main built-in antenna.

16. The terminal of claim 14, wherein the external case includes an attachment part for retaining the wireless terminal and a folder part for rotating with respect to the attachment part.

17. The terminal of claim 16, wherein at least one of the attachment part and the folder part include the antenna radiator.

18. The terminal of claim 16, wherein the attachment part includes an attachment plate for retaining the wireless terminal, and for one of covering and surrounding the wireless terminal near the folder part.

19. The terminal of claim 18, wherein the attachment part comprises at least one pair of cantilever snap-fits for retaining the wireless terminal, wherein each cantilever snap-fits engages an opposite portion of the wireless terminal and projects upwardly from an upper part of the attachment plate.

20. The terminal of claim 18, wherein the attachment part comprises a fixing protrusion and a cantilever snap-fit, facing each other, for retaining the wireless terminal, wherein the fixing protrusion projects perpendicularly from a side surface of the attachment plate, and the cantilever snap-fit projects upwardly from an upper part of the attachment plate, and further wherein the wireless terminal includes a groove corresponding to the fixing protrusion.

21. The terminal of claim 18, wherein the attachment part comprises at least one pair of fixing protrusion, facing each other, for retaining the wireless terminal, wherein each fixing protrusion projects perpendicularly from a side surface of the attachment plate, and the attachment plate is flexural and recoverable, further wherein the wireless terminal includes grooves corresponding to the fixing protrusions.

22. The terminal of claim 16, wherein the attachment part comprises a wall projecting upwardly from an upper part of the attachment plate, following the contour of the wireless terminal, for preventing the wireless terminal from separating horizontally from the attachment part.

23. The terminal of claim 14, wherein the antenna radiator comprises one of a monopole type antenna and a dipole type antenna.

24. The terminal of claim 14, wherein the antenna radiator comprises at least one of a conductive plate, a Flexible Circuit Board (FPCB) and a sprayed film.

25. The terminal of claim 14, wherein the antenna radiator transmits and receives signals of at least one of a Digital Multimedia Broadcasting (DMB) and a wireless local area network.

26. The terminal of claim 15, wherein the control part selectively controls use of the at least one of the at least one antenna radiator and the main built-in antenna by comparing a signal strength of the at least one radiator with a signal strength of the main built-in antenna.
